(19) United States
(12) Patent Application Publication
(10) Pub. No.: US 2003/0120638 A1
(43) Pub. Date: Jun. 26, 2003

(54) Method and apparatus for caching multiple Java-database connectivity

(76) Inventors: Joong Ki Park, Taejon (KR); Kyoung Ho Lee, Taejon (KR); Joong Bae Kim, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/147,804

(22) Filed: May 20, 2002

(30) Foreign Application Priority Data
Dec. 24, 2001 (KR) 2001-84216

(51) Int. Cl. G06F 7/00

(52) U.S. Cl. 707/3

(57) ABSTRACT

A system and method of caching multiple Java-database connectivity is disclosed. A cache manager for cache management is provided between an intermediate server and a database server in the multi-layer Java-database connectivity system having the intermediate server. If the intermediate server provides a query statement for accessing a database, the caching of the intermediate server is operated in a different manner according to the kind of the query statement. Thus, a response time of the system can be reduced from the viewpoint of a user, and the load of the network can be reduced through reduction of the network traffic from the viewpoint of a network. Also, the load of the database server for service requests can be reduced, and a database management system can process more requests from users.

### BACKGROUND OF THE INVENTION

1. Field of the Invention

The present invention relates to a method and apparatus for caching multiple Java-database connectivity, and more particularly, to a method and apparatus for caching multiple Java-database connectivity that is designed to manage data status information and dynamic data to keep the consistency of the dynamic data stored in a cache.

2. Backyround of the Related Art

A Java language is a computer language having the characteristic of “write once, run anywhere” through an independent object support, superior exception process, and multi-thread support to hardware, and has been widely used for the software development of diverse fields.

Internet application services using the Java mostly use databases, and thus, for their compatibilities, there has been a demand for a method capable of developing an application program irrespective of a specified database management system.

Accordingly, Java developers have set a standard for a user interface, i.e., Java database connectivity (JDBC), so that they can use databases through a unified programming method.

As interface methods for accessing databases from the viewpoint of the Java users, there exist a method using the Java-database connectivity in that an open database connectivity (ODBC) defined so that the existing general application programs can use the database in the unified manner is changed to an interface of a Java language, a method using a user library provided from a specified database management system, and a method using an intermediate server program irrespective of a specified database management system.

The caching technique is for temporarily storing frequently used commands and data in a quick storage device in order to improve a command processing speed between a central processing unit in a computer and a main memory or between the main memory and an auxiliary memory.

In the Internet application service environment, the caching technique can improve a data access speed by storing the frequently used data in a near place.

What is considered when the computer stores data in a cache is to heighten a hit rate of the cache. The cache hit rate can be heightened through storing of the frequently used data in the cache and heightening of the frequency in use of the data, and the data stored in the cache should be always kept identical to the original data.

That is because if the data stored in the cache is not kept identical to the original data, the data integrity cannot be guaranteed.

However, the conventional cache management method as described above is mainly for dealing with static data. Thus, though it is suitable for the data environment in that the contents which the user requests to the cache are not newly obtained through a certain process, but already exist in a static state in a file system and so on, it cannot properly cope with the dynamic data processing environment in that an intermediate server in a multi-layer Java-database connectivity system receives user's requests, and a database server processes the requests in a separate manner.

### SUMMARY OF THE INVENTION

Accordingly, the present invention is directed to a method and apparatus for cache management in a multi-layer Java-database connectivity system that substantially obviates one or more problems due to limitations and disadvantages of the related art.

It is an object of the present invention to provide a method and apparatus for cache management that is designed to manage data status information and dynamic data to keep the consistency of the dynamic data stored in a cache in a multi-layer Java-database connectivity system.

It is another object of the present invention to provide a recording medium readable by a computer in which a program for implementing the cache management method is recorded.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a cache management method in a multi-layer Java-database connectivity unification system having a Java-database connectivity driver and a database server, the method comprising the steps of if a database query statement is received from the Java-database connectivity driver, judging a kind of the query statement by analyzing the received query statement, and a) if data corresponding to the query statement exists in a cache as a result of judging the kind of the query statement, transferring the corresponding data to the Java-database connectivity driver, while b) if the data corresponding to the query statement does not exist in the cache, requesting the corresponding data to the database server and providing the data to the Java-database connectivity driver.

The step of providing the data to the Java-database connectivity driver may comprise the steps of if the kind of the query statement is a data change statement, judging whether the data corresponding to the data change statement exists in the cache, and a) if the data corresponding to the data change statement exists in the cache as a result of judgment, setting the corresponding data to be in a “changed” state, and then transferring the data change statement to the database server to change the corresponding data, while b) if the data corresponding to the data change statement does not exist in the cache, transferring the data change statement directly to the database server to change the corresponding data.

The step of providing the data to the Java-database connectivity driver may comprise the steps of if the kind of the query statement is a data search statement, judging whether a search result data corresponding to the data search statement exists in the cache and the corresponding data is in an “updated” state, and if the search result data corresponding to the data search statement exists in the cache and the corresponding data is in the “updated’ state as a result of judgment, transferring the corresponding data existing in the cache to the Java-database connectivity driver.

The step of providing the data to the Java-database connectivity driver may further comprise the steps of if the search result data corresponding to the data search statement exists in the cache and the corresponding data is not in the “updated’ state as a result of judgment, transferring the corresponding data search statement to the database server, and a) if the search result data corresponding to the data search statement is received from the database server, providing the received search result data to the Java-database connectivity driver, and b) adding the data search statement to a cache query statement list, and adding the search result data to an attribute list.

The step of judging the kind of the query statement by analyzing the received query statement may comprise the steps of if the query statement is not received, judging whether the data in the “changed” state exists among cache data, and if the data in the “changed” state exists among the cache data as a result of judgment, receiving resultant data of query statement process from the database server, storing the resultant data in the cache, and setting the data to be in an “updated” state.

In another aspect of the present invention, there is provided a cache management apparatus in a multi-layer Java-database connectivity unification system having a Java-database connectivity driver and a database server, the apparatus comprising a cache storage section for storing a plurality of cache data and information, and a cache management section for a) if a database query statement is received from the Java-database connectivity driver, judging a kind of the query statement by analyzing the received query statement, and if data corresponding to the query statement exists in the cache storage section according to the kind of the query statement, transferring the corresponding data to the Java-database connectivity driver, while b) if the data corresponding to the query statement does not exist in the cache storage section, requesting the corresponding data to the database server and providing the data to the Java-database connectivity driver.

The plurality of cache data and information stored in the cache storage section may include at least one of cache query statement list data information corresponding to the data currently stored, resultant data of the query statement existing in the cache query statement list, and status information of the resultant data of the query statement.

The cache management section, if the kind of the query statement is a data change statement, a) judges whether the data corresponding to the data change statement exists in the cache, b) if the data corresponding to the change statement exists in the cache as a result of judgment, sets the corresponding data to be in a “changed” state, and then transfers the data change statement to the database server to change the corresponding data, and c) if the data corresponding to the data change statement does not exist in the cache, transfers the data change statement directly to the database server to change the corresponding data.

The cache management section, if the kind of the query statement is a data search statement, a) judges whether search result data corresponding to the data search statement exists in the cache and the corresponding data is in an “updated” state, and b) if the search result data corresponding to the data search statement exists in the cache and the corresponding data is in the “updated’ state as a result of judgment, transfers the corresponding data existing in the cache to the Java-database connectivity driver.

The cache management section, if the search result data corresponding to the data search statement exists in the cache and the corresponding data is not in the “updated” state as a result of judgment, a) transfers the corresponding search statement to the database server, and if the search result data is received from the database server as a result of search, provides the received search result data to the Java-database connectivity driver, and b) additionally stores the search statement and the search result data in the cache storage section.

In still another aspect of the present invention, there is provided a recording medium that implements by types a program of commands executable by a digital processing apparatus to perform a cache management method in a multi-layer Java-database connectivity unification system having a Java-database connectivity driver and a database server, and that is readable by the digital processing apparatus, the recording medium performing the steps of if a database query statement is received from the Java-database connectivity driver, judging a kind of the query statement by analyzing the received query statement; a) if the kind of the query statement is a data change statement and data changed according to the data change statement is stored in a cache, setting the corresponding data to be in a “changed” state, and b) if the changed data does not exist in the cache, transferring the data change statement to the database server so that the database server changes the data according to the data change statement; and a) if the kind of the query statement is a data search statement, and if the data to be searched according to the data search statement exists in the cache and the data is in an “updated” state, transferring the data to the Java-database connectivity driver, and b) if the data to be searched exists in the cache and the data is not in the “updated’ state, transferring the search statement to the database server to have the database server process the data search statement, checking if it is necessary to store a search result in the cache, and adding the searched data in the cache.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a system for caching multiple Java-database connectivity according to the present invention.

FIGS. 2A and 2B are a flowchart illustrating a method of caching multiple Java database connectivity according to the present invention.

### DETAILED DESCRIPTION OF THE PREFERRED EMBODIMENT

The apparatus and method for communication with reality in virtual environments according to the preferred embodiment of the present invention will now be explained in detail with reference to the accompanying drawings.

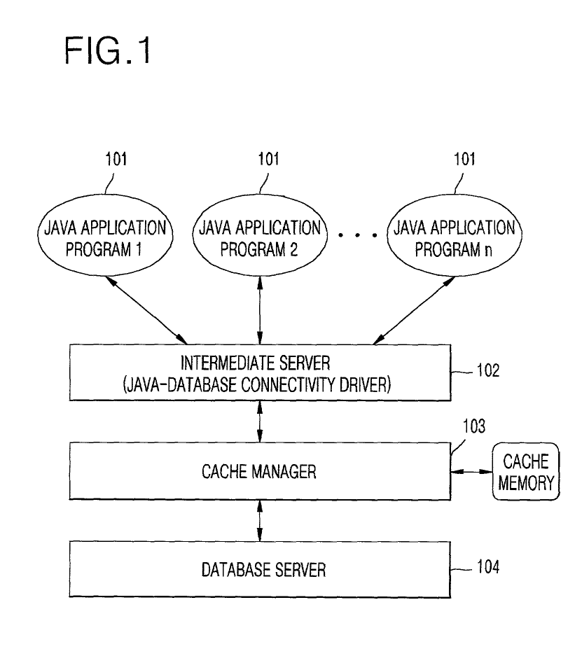

FIG. 1 is a view illustrating a system for caching multiple Java-database connectivity according to the present invention. The system is provided with a Java application program 101, a Java-database connectivity driver 102 that is an intermediate server, a cache manager 103, and a database server 104. Here, to the cache manager 103 is connected a cache memory.

According to the system for caching multiple Java-database connectivity of FIG. 1, the cache manager 103 is placed between the intermediate server 102 and the database server 104, and stores frequently requested data among dynamic data that the intermediate server requests to the database server 104 by caching the data.

If the Java application program requests to the intermediate server 102 access of the database in the form of a standardized query statement, the intermediate server 102 transfers a command to the database server 102.

At this time, the cache manager 103 analyzes the query statement requested from the intermediate server 102 to the database server 104, and if the updated contents of the corresponding data exist in the cache memory, the cache manager 103 transfers the contents in the cache memory to the intermediate server 102 instead of transferring the command to the database server 104.

The cache manager 103 stores and keeps the updated contents for the frequently requested query statement in the cache memory.

Also, the data structure of the cache stored in the cache memory includes cache query statement list data for the data currently stored in the cache memory, data status data stored in the cache corresponding to the query statements in the cache query statement list (if the query statement is in the “updated” state, it means that the contents of the cache for the query statement is identical to the contents existing in the database server, while if the query statement is in the “changed” state, it means that the contents of the cache corresponding to the query statement is different from the contents existing in the database server), and attribute query statement data which manages table query statement data for respective tables used in the respective query statements in the cache query list as a set and which is a set of the query statements using attributes used in the query statements in the cache query statement list.

An example of the respective data structure in case that the updated contents for three query statement are stored in the cache is shown below.

Query Statement

S1: SELECT a, b FROM t1

S2: SELECT x, y FROM t2 WHERE x>2

S3: SELECT a FROM t1, t2 WHERE b=x

Here, it is assumed that the table t1 has two attributes (a, b), and the table t2 has attributes (x, y, z).

Cache Query Statement List

S1, S2, S3

Status of Query Statement

S1->Updated, S2->Updated, S3->Updated

Table Query Statement

t1.a->{S1, S3}

t1.b->{S1, S3}

t2.x->{S2, S3}

t2.y->{S21}

The cache manager 103 is a program always performed by the computer that drives the intermediate server 102, i.e., Java-database connectivity driver, and is provided between the intermediate server 102 and the database server 104. The cache manager analyzes the query statement requested from the intermediate server 102 to the database server 104, and stores the data corresponding to the frequently requested query statement in the cache memory to keep the data consistency.

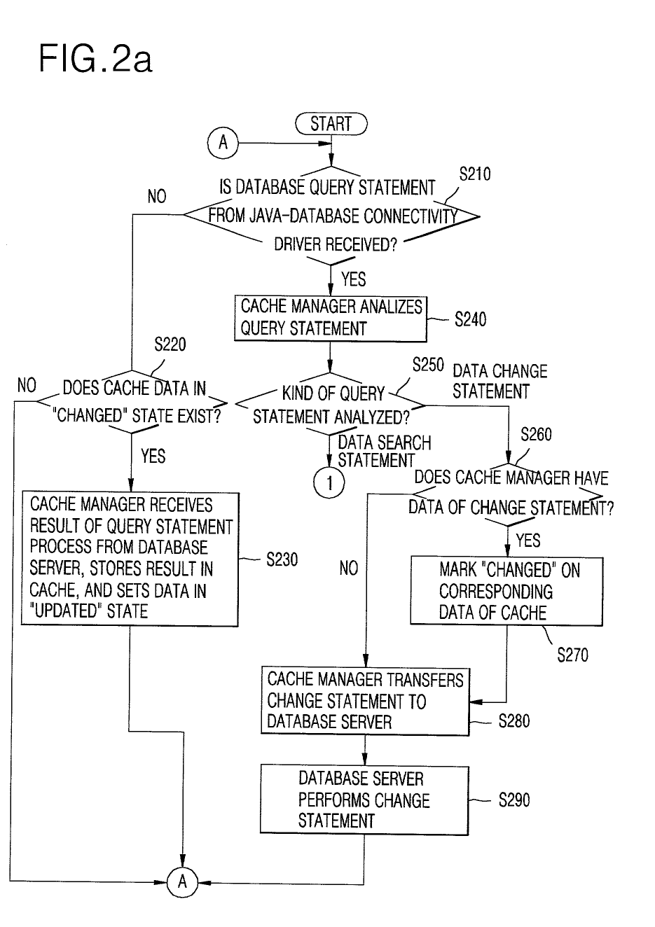

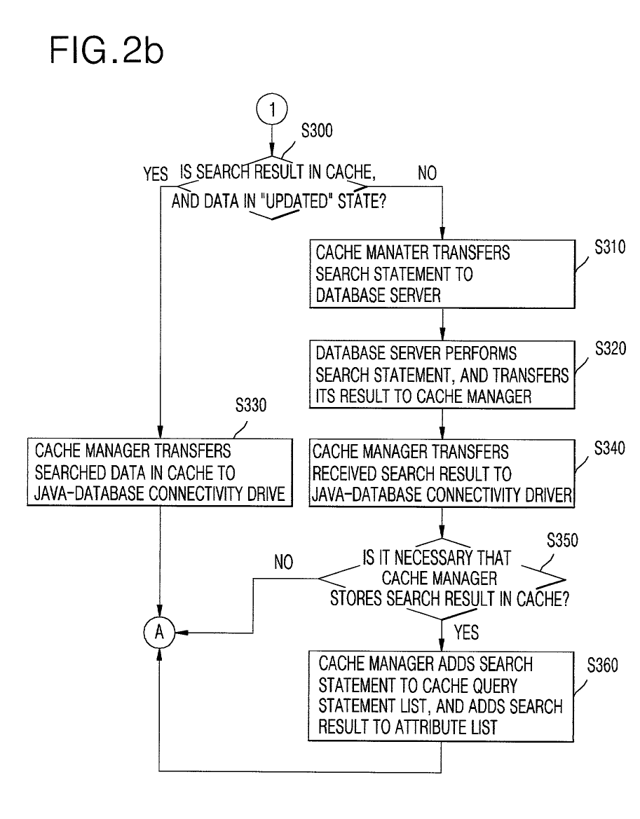

The method of caching multiple Java-database connectivity according to the present invention using the system for caching multiple Java-database connectivity as described above will be explained in detail with reference to FIGS. 2A and 2B.

FIGS. 2A and 2B are a flowchart illustrating the method of caching multiple Java database connectivity according to the present invention.

Referring to FIGS. 2A and 2B, the cache manager 103 judges whether the query statement for requesting the database access is received from the Java-database connectivity driver 102 (step S210).

If the query statement for requesting the database access is not received as a result of judgment, the cache manager checks if any data that is in the “changed” state exists in the cache (step S220).

If the data that is in the “changed” state exists in the cache as a result of checking, the cache manager receives and stores in the cache memory the corresponding query result from the database server 104, and sets the data to be in the “updated” state (step S230).

Meanwhile, if the query statement for requesting the database access is received as a result of checking if the query statement is received from the Java-database connectivity driver 102 at the step S21 0, the cache manager 102 analyzes the query statement (step S240), and judges the kind of the query statement (step S250).

If the corresponding query statement is the data change statement as a result of judgment, the cache manager judges whether the cache memory has the data changed according to the data change statement (step S260).

If the cache memory has the data changed according to the data change statement as a result of judgment, the cache manager sets the corresponding data of the cache to be the “changed” state (step S270), and transfers the data change statement to the database server 104 (step S280).

The database server 104 changes the data according to the data change statement transferred from the cache manager 103 (step S290).

At the step S260, however, if the cache memory does not have the data changed according to the data change statement, the cache manager 103 transfers the change statement directly to the database server to change the corresponding data.

Meanwhile, if the kind of the query statement is the data search statement as a result of judgment at the step S250, the cache manager judges whether the data searched according to the data search statement exists in the cache, and the data is in the “updated” state (step S300).

If the search result of the search statement exists in the cache memory, and the data is in the “updated” state as a result of judgment, the cache manager transfers the searched data existing in the cache memory to the Java-database connectivity driver 102 (step S320).

At the step S300, however, if the data searched according to the data search statement exists in the cache memory, and the data is not in the “updated” state, the cache manager 103 transfers the data search statement from the Java-database connectivity driver 102 to the database server 104 (step S310).

Then, the database server 104 searches the data according to the data search statement transferred from the cache manager 103, and transfers the searched data to the cache manager 103 (step S330).

Thereafter, the cache manager 103 receives the searched data from the database server 104, transfers the received data to the Java-database connectivity driver 102 (step S340), and then checks if it is necessary to store the data searched by the database server 104 in the cache memory (step S3 50).

If it is necessary to store the data searched by the database server 104 in the cache memory, the cache manager 103 adds the searched result to the cache memory, adds the data search statement to the cache query statement list, and then corrects the attribute query statement (step S360).

As described above, according to the system and method of caching multiple Java-database connectivity according to the present invention, a cache manager for managing caching is provided between an intermediate server and a database server in the multi-layer Java-database connectivity system having the intermediate server, and if the intermediate server provides a query statement for accessing a database, the caching of the intermediate server is operated in a different manner according to the kind of the query statement. Thus, a response time of the system can be reduced from the viewpoint of the user, and the load of the network can be reduced through reduction of the network traffic from the viewpoint of the network. Also, the load of the database server for the service requests can be reduced, and thus the database management system can process more requests from users.

The forgoing embodiment is merely exemplary and is not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method of caching multiple Java-database connectivity in a cache management method for a multi-layer Java-database connectivity unification system having a Java-database connectivity driver and a database server, the method comprising the steps of:
if a database query statement is received from the Java-database connectivity driver, judging a kind of the query statement by analyzing the received query statement; and
a) if data corresponding to the query statement exists in a cache as a result of judging the kind of the query statement, transferring the corresponding data to the Java-database connectivity driver, while b) if the data corresponding to the query statement does not exist in the cache, requesting the corresponding data to the database server and providing the data to the Java-database connectivity driver.

2. The method as claimed in claim 1, wherein the step of providing the data to the Java-database connectivity driver comprises the steps of:
if the kind of the query statement is a data change statement, judging whether the data corresponding to the data change statement exists in the cache; and
a) if the data corresponding to the data change statement exists in the cache as a result of judgment, setting the corresponding data to be in a “changed” state, and then transferring the data change statement to the database server to change the corresponding data, while b) if the data corresponding to the data change statement does not exist in the cache, transferring the data change statement directly to the database server to change the corresponding data.

3. The method as claimed in claim 1, wherein the step of providing the data to the Java-database connectivity driver comprises the steps of:
if the kind of the query statement is a data search statement, judging whether a search result data corresponding to the data search statement exists in the cache and the corresponding data is in an “updated’ state; and
if the search result data corresponding to the data search statement exists in the cache and the corresponding data is in the “updated” state as a result of judgment, transferring the corresponding data existing in the cache to the Java-database connectivity driver.

4. The method as claimed in claim 3, wherein the step of providing the data to the Java-database connectivity driver further comprises the steps of:
if the search result data corresponding to the data search statement exists in the cache and the corresponding data is not in the “updated’ state as a result of judgment, transferring the corresponding data search statement to the database server; and
a) if the search result data corresponding to the data search statement is received from the database server, providing the received search result data to the Java-database connectivity driver, and b) adding the data search statement to a cache query statement list, and adding the search result data to an attribute list.

5. The method as claimed in claim 1, wherein the step of judging the kind of the query statement by analyzing the received query statement comprises the steps of:
if the query statement is not received, judging whether the data in the “changed” state exists among cache data; and
if the data in the “changed” state exists among the cache data as a result of judgment, receiving resultant data of query statement process from the database server, storing the resultant data in the cache, and setting the data to be in an “updated” state.

6. A system for caching multiple Java-database connectivity in a cache management apparatus of a multi-layer Java-database connectivity unification system having a Java-database connectivity driver and a database server, the system comprising:
a cache storage section for storing a plurality of cache data and information; and
a cache management section for a) if a database query statement is received from the Java-database connectivity driver, judging a kind of the query statement by analyzing the received query statement, and if data corresponding to the query statement exists in the cache storage section according to the kind of the query statement, transferring the corresponding data to the Java-database connectivity driver, while b) if the data corresponding to the query statement does not exist in the cache storage section, requesting the corresponding data to the database server and providing the data to the Java-database connectivity driver.

7. The system as claimed in claim 6, wherein the plurality of cache data and information stored in the cache storage section includes at least one of cache query statement list data information corresponding to the data currently stored, resultant data of the query statement existing in the cache query statement list, and status information of the resultant data of the query statement.

8. The system as claimed in claim 6, wherein if the kind of the query statement is a data change statement, the cache management section
a) judges whether the data corresponding to the data change statement exists in the cache;
b) if the data corresponding to the change statement exists in the cache as a result of judgment, sets the corresponding data to be in a “changed” state, and then transfers the data change statement to the database server to change the corresponding data; and
c) if the data corresponding to the data change statement does not exist in the cache, transfers the data change statement directly to the database server to change the corresponding data.

9. The system as claimed in claim 6, wherein if the kind of the query statement is a data search statement, the cache management section
a) judges whether search result data corresponding to the data search statement exists in the cache and the corresponding data is in an “updated” state; and
b) if the search result data corresponding to the data search statement exists in the cache and the corresponding data is in the “updated’ state as a result of judgment, transfers the corresponding data existing in the cache to the Java-database connectivity driver.

10. The system as claimed in claim 9, wherein if the search result data corresponding to the data search statement exists in the cache and the corresponding data is not in the “updated” state as a result of judgment, the cache management section
a) transfers the corresponding search statement to the database server, and if the search result data is received from the database server as a result of search, provides the received search result data to the Java-database connectivity driver; and
b) additionally stores the search statement and the search result data in the cache storage section.

11. A recording medium that implements by types a program of commands executable by a digital processing apparatus to perform a cache management method in a multi-layer Java-database connectivity unification system having a Java-database connectivity driver and a database server, and that is readable by the digital processing apparatus, the recording medium performing the steps of:
if a database query statement is received from the Java-database connectivity driver, judging a kind of the query statement by analyzing the received query statement;
a) if the kind of the query statement is a data change statement and data changed according to the data change statement is stored in a cache, setting the corresponding data to be in a “changed” state, and b) if the changed data does not exist in the cache, transferring the data change statement to the database server so that the database server changes the data according to the data change statement; and
a) if the kind of the query statement is a data search statement, and if the data to be searched according to the data search statement exists in the cache and the data is in an “updated” state, transferring the data to the Java-database connectivity driver, and b) if the data to be searched exists in the cache and the data is not in the “updated’ state, transferring the search statement to the database server to have the database server process the data search statement, checking if it is necessary to store a search result in the cache, and adding the searched data in the cache.
